(19) United States
(12) Patent Application Publication
(10) Pub. No.: US 2025/0361398 A1
(43) Pub. Date: Nov. 27, 2025

(54) POLYURETHANE COMPOSITION SUITABLE AS BUILDING WATERPROOFING SYSTEM AND HAVING EXTENDED POT LIFE

(71) Applicant: SIKA TECHNOLOGY AG, Baar (CH)

(72) Inventors: Stephen GLOVER, Chorley (GB); Michael BYRNE, Lytham (GB); Michelle ROUND, Leyland (GB)

(73) Assignee: SIKA TECHNOLOGY AG, Baar (CH)

(21) Appl. No.: 18/871,613

(22) PCT Filed: Jul. 4, 2023
(86) PCT No.: PCT/EP2023/068393

§ 371 Date: Dec. 4, 2024

(30) Foreign Application Priority Data
Jul. 6, 2022 (EP) 22183343.7

(51) Int. Cl. C08L 75/08; C08K 5/053

(52) U.S. Cl. CPC C08L 75/08; C08K 5/053

(57) ABSTRACT

A polyurethane composition includes a first component A and a second component B, wherein the first component A includes a polyol mixture P, including at least one polyol P1 having an average molecular weight of 800 to 30 000 g/mol, wherein the polyol P1 is a polyhydroxy-functional fat and/or a polyhydroxy-functional oil, or a polyol obtained by chemically modifying natural fats and/or natural oils; and the second component B includes at least one aliphatic polyisocyanate I. The polyurethane composition includes fillers F, an acid SA having a pKₐ of ≤4.9, a tin catalyst K and a compound T having at least one thiol group. The molar ratio of all thiol groups in the at least one compound T to all metal atoms in the at least one tin catalyst K (T/K) is from 2.75:1 to 10:1 here.

### TECHNICAL FIELD

The invention relates to the field of polyurethane compositions and to the use thereof, especially as a building waterproofing system.

### PRIOR ART

Two-component polymethyl methacrylate compositions have already been used for some time as roof coatings. They have the advantage that they cure rapidly after mixing and can therefore be walked on after a shorter time. They also meet the demands placed on a permanent, weather- and water-resistant roof coating. However, such systems have the disadvantage of high VOC emissions.

Building waterproofing systems and a roof coating in particular should ideally, irrespective of the curing conditions, have both a long pot life and a short curing time. What is desirable would be an open time of 15 min to 45 min and a curing time of 60 min to 220 min under curing conditions over the entire temperature range of 5° C. to 21° C., especially at 90% relative humidity.

When using two-component polyurethane compositions for use as building waterproofing systems, it would therefore be desirable to be able to combine an adequately long pot life for application to the substrate with subsequent rapid curing and a short wait time until the coating is ready to be worked on further/walked on. This is however barely achievable with today's two-component polyurethane compositions. Either the pot life is too short in the case of compositions that cure and develop strength rapidly or else curing and the development of strength are slow when working with compositions that have a long pot life.

In other technical fields, two-component polyurethane compositions have been developed that have a long pot life that is even adjustable within certain limits, thus making it possible to work with larger components or production parts too, but that after application also cure very rapidly and exhibit strengths and elasticity, in the sense of structural bonding, within hours to a few days. Such a two-component polyurethane composition in the field of structural adhesives is disclosed in WO 2019/002538 A1. This publication teaches special catalyst systems comprising a metal catalyst and compounds containing thiol groups, which allow an adjustable pot life and subsequent rapid curing of the composition.

WO 2022043383 A1 relates to the field of floor coatings and discloses a two-component polyurethane compositions comprising a metal catalyst and compounds containing thiol groups in which the pot life and the curing of the composition can be adapted to the curing conditions.

In the field of the coatings industry, EP 0454219 discloses a polyurethane composition based on polyacrylic polyols, aliphatic polyisocyanates, a dibutyltin dilaurate catalyst complexed with trimethylolpropane tris(3-mercaptopropionate), and a high proportion of organic solvents.

US 2019/0106527 A1 discloses coatings for vehicles comprising a polyol, preferably polyester polyols or polyacrylate polyols, a polyisocyanate, a catalyst, a tertiary acid, optionally a complexing agent containing at least one-SH group, and a high proportion of organic solvents.

It would therefore be desirable to provide polyurethane compositions for roof coating that, irrespective of the curing conditions, have both a long pot life and a short curing time. What is desirable would be a pot life of 15 min to 45 min and a curing time of 60 min-220 min under curing conditions over the entire temperature range of 5° C. to 21° C., especially at 90% relative humidity.

### SUMMARY OF THE INVENTION

An object of the present invention is therefore to provide polyurethane compositions for roof coatings that, irrespective of the curing conditions, have both a long pot life and a short curing time.

This object is surprisingly achieved with the polyurethane composition of the invention as claimed in claim 1. Further aspects of the invention are the subject of further independent claims. Particularly preferred embodiments of the invention are the subject of the dependent claims.

### Ways of Executing the Invention

The present invention relates to a polyurethane composition comprising a first component A and a second component B, wherein
the first component A comprises
   a polyol mixture P, comprising
      at least one polyol P1 having an average molecular weight of 800 to 30 000 g/mol, preferably 850 to 20 000 g/mol, more preferably 900 to 10 000 g/mol, wherein the polyol P1
   is a polyhydroxy-functional fat and/or a polyhydroxy-functional oil, or a polyol obtained by chemically modifying natural fats and/or natural oils; and
      preferably at least one polyol P2 selected from the group consisting of polyester polyols and polyether polyols; and
the second component B comprises
   at least one aliphatic polyisocyanate I;
wherein the polyurethane composition additionally contains 5% by weight to 70% by weight, preferably 20% by weight to 50% by weight, of at least one filler F, based on the total weight of the polyurethane composition, and wherein the polyurethane composition additionally contains 0.7-2.9 mM, based on 100 g of the polyurethane composition, of at least one acid SA having a pKₐ of ≤4.9,
and at least one tin catalyst K for the reaction of hydroxyl groups and isocyanate groups that is capable of forming thio complexes, and at least one compound T having at least one thiol group, the molar ratio of all thiol groups in the at least one compound T to all metal atoms in the at least one tin catalyst K (T/K) being from 2.75:1 to 10:1 and the molar ratio of all NCO groups in the polyurethane composition to all metal atoms in the at least one tin catalyst K (NCO/K) preferably being from 20 to 200.

The prefix “poly” in substance names such as “polyol”, “polyisocyanate”, “polyether” or “polyamine” in the present document indicates that the respective substance formally contains more than one of the functional group that occurs in its name per molecule.

The term “polymer” in the present document encompasses firstly a collective of macromolecules that are chemically uniform but differ in the degree of polymerization, molar mass, and chain length, said collective having been produced by a “poly” reaction (polymerization, polyaddition, polycondensation).

The term secondly also encompasses derivatives of such a collective of macromolecules from “poly” reactions, i.e. compounds obtained by reactions, for example additions or substitutions, of functional groups on defined macromolecules and that may be chemically uniform or chemically nonuniform.

The term further encompasses so-called prepolymers too, i.e. reactive oligomeric initial adducts, the functional groups of which are involved in the formation of macromolecules.

“Molecular weight” is in the present document understood as meaning the molar mass (in grams per mole) of a molecule or a molecule residue. “Average molecular weight” refers to the number-average Mn of a polydisperse mixture of oligomeric or polymeric molecules or molecule residues, which is normally determined by gel-permeation chromatography (GPC) against polystyrene as standard.

Percent by weight values, abbreviated to % by weight, refer to the proportions by mass of a constituent in a composition based on the overall composition, unless otherwise stated. The terms “mass” and “weight” are used synonymously in the present document.

A “primary hydroxyl group” refers to an OH group attached to a carbon atom having two hydrogens.

“Pot life” refers in this document to the time within which, after mixing the components, the polyurethane composition can be worked with before the viscosity resulting from the progression of the crosslinking reaction has become too high for further processing.

“Curing time” refers in this document to the time needed to ensure adequate hardness of the polyurethane composition, especially in respect of it being ready to be worked on further/walked on.

The term “strength” in the present document refers to the strength of the cured composition, strength meaning in particular the tensile strength and modulus of elasticity, particularly in the 0.05% to 0.25% elongation range or in the 0.5 to 5.0% range.

“Room temperature” in the present document refers to a temperature of 23° C. A substance or a composition is described as “storage-stable” or “storable” if it can be stored at room temperature in a suitable container for a relatively long period, typically at least 3 months up to 6 months or longer, without this storage resulting in any change in its application properties or use properties, especially in the viscosity and crosslinking rate, to an extent relevant to its use.

All industry standards and norms mentioned in this document relate to the versions valid at the date of first filing.

The “average OH functionality” is the number of OH groups per polymer molecule, averaged over all polymer molecules. If, for example, 50% of all polymer molecules contain two hydroxyl groups and the other 50% contain three, the result is an average OH functionality of 2.5. The average OH functionality can in particular be determined by calculation from the hydroxyl value and the molecular weight Mn determined via GPC.

The polyurethane composition of the invention comprises a first component A and a second component B, which are mixed only on application of the polyurethane composition and are stored prior to this in separate packages.

The first component A comprises a polyol mixture P.

Preferably, the proportion of the polyol mixture P is from 5% by weight to 90% by weight, preferably 10% by weight to 80% by weight, 20% by weight to 70% by weight, 30% by weight to 60% by weight, especially 40% by weight to 50% by weight, based on component A.

It can also be advantageous when the proportion of the polyol mixture P is from 5% by weight to 70% by weight, preferably 10% by weight to 60% by weight, 15% by weight to 50% by weight, 20% by weight to 45% by weight, especially 30% by weight to 40% by weight, based on the total weight of the polyurethane composition.

The polyol mixture P comprises at least one polyol P1 having an average molecular weight of 800 to 30 000 g/mol, preferably 850 to 20 000 g/mol, more preferably 900 to 10 000 g/mol, wherein the polyol P1 is a polyhydroxy-functional fat and/or a polyhydroxy-functional oil or a polyol obtained by chemically modifying natural fats and/or natural oils.

Examples of chemically modified natural fats and/or oils are polyols obtained from epoxy polyesters or epoxy polyethers, which are obtained for example by epoxidation of unsaturated oils, by subsequent ring opening with carboxylic acids or alcohols, polyols obtained by hydroformylation and hydrogenation of unsaturated oils, or polyols obtained from natural fats and/or oils by degradation processes such as alcoholysis or ozonolysis and subsequent chemical linkage of the degradation products thus obtained or derivatives thereof, for example by transesterification or dimerization. Also suitable are polyols obtained by polyoxyalkylation of natural oils such as castor oil and available for example under the Lupranol Balance® trade name from Elastogran GmbH. Suitable breakdown products of natural fats and/or oils are in particular fatty acids and fatty alcohols and fatty acid esters, in particular the methyl esters (FAME), which can be derivatized to hydroxy fatty acid esters, for example by hydroformylation and hydrogenation.

The polyols P1 mentioned above usually have a relatively high average molecular weight of between 800 and 30 000 g/mol, preferably between 850 and 20 000 g/mol, more preferably between 900 and 10 000 g/mol, and preferably an average OH functionality within a range of from 1.6 to 3.

Preferably the polyol P1 is castor oil or a chemical modification thereof, especially a chemical modification of castor oil, most preferably a reaction product of castor oil with ketone resins.

Particularly preferably, the polyol P1 is a polyol having an OH value of 110 to 200 mg KOH/g. The OH value is preferably from 140 to 190 mg, especially 140 to 170 mg, more preferably 150 to 170 mg KOH/g.

Particular preference is given to reaction products of castor oil with cyclohexanone-based ketone resins, especially those sold for example by Nuplex Resins GmbH, Germany under the names Setathane® 1150, Setathane® 1155, and Setathane® 1160.

In the present document, the term “castor oil” is preferably understood as meaning castor oil as described in the online Römpp Chemie Lexikon (Thieme Verlag), retrieved on 23 Dec. 2016.

In the present document, the term “ketone resin” is preferably understood as meaning ketone resin as described in the online Römpp Chemie Lexikon, Thieme Verlag, retrieved on 23 Dec. 2016.

The polyol mixture P preferably comprises at least one polyol P2 selected from the group consisting of polyester polyols and polyether polyols.

The polyol P2 has in all embodiments preferably an average molecular weight within a range of from 400 to 6000 g/mol, especially 450 to 5500 g/mol, more preferably 500 to 5000 g/mol, 750 to 3000 g/mol, most preferably 1000 to 2000 g/mol.

The polyol P2 has in all embodiments preferably an average OH functionality within a range of from 2 to 4, especially 2 to 3.5, more preferably 2 to 3.

The polyol P2 has in all embodiments preferably an OH value within a range of from 20 to 600 mg KOH/g, 50 to 600 mg KOH/g, 100 to 600 mg KOH/g, especially 200 to 600 mg KOH/g, 300 to 600 mg KOH/g, more preferably 350 to 600 mg KOH/g.

Polyether polyols, also termed polyoxyalkylene polyols or oligoetherols, suitable as polymer P2 are in particular those that are polymerization products of ethylene oxide, 1,2-propylene oxide, 1,2- or 2,3-butylene oxide, oxetane, or mixtures thereof, optionally polymerized with the aid of a starter molecule having two or more active hydrogen atoms such as water, ammonia or compounds having a plurality of OH or NH groups, for example ethane-1,2-diol, propane-1,2-diol and -1,3-diol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, cyclohexane-1,3-dimethanol and -1,4-dimethanol, bisphenol A, hydrogenated bisphenol A, 1,1,1-trimethylolethane, 1,1,1-trimethylolpropane, glycerol, aniline, and also mixtures of the recited compounds. It is possible to use both polyoxyalkylene polyols having a low degree of unsaturation (measured in accordance with ASTM D-2849-69 and expressed in milliequivalents of unsaturation per gram of polyol (mEq/g)), produced for example using so-called double metal cyanide complex catalysts (DMC catalysts), and polyoxyalkylene polyols having a higher degree of unsaturation, produced for example using anionic catalysts such as NaOH, KOH, CsOH or alkali metal alkoxides.

Particularly suitable as polyol P2 are polyoxyethylene polyols and polyoxypropylene polyols, especially polyoxyethylene diols, polyoxypropylene diols, polyoxyethylene triols, and polyoxypropylene triols.

Especially suitable as polyol P2 are polyoxyalkylene diols or polyoxyalkylene triols having a degree of unsaturation lower than 0.02 mEq/g and having a molecular weight within a range of from 1000 to 15 000 g/mol, as are polyoxyethylene diols, polyoxyethylene triols, polyoxypropylene diols, and polyoxypropylene triols having a molecular weight of 400 to 15 000 g/mol. Likewise particularly suitable as polyol P2 are what are known as ethylene oxide-terminated (“EO-endcapped”, ethylene oxide-endcapped) polyoxypropylene polyols. The latter are special polyoxypropylene polyoxyethylene polyols that are obtained for example when pure polyoxypropylene polyols, especially polyoxypropylene diols and triols, are at the end of the polypropoxylation reaction further alkoxylated with ethylene oxide and thus have primary hydroxyl groups. Preference in this case is given to polyoxypropylene polyoxyethylene diols and polyoxypropylene polyoxyethylene triols.

Suitable polyether-based polymers P2 of this kind are available for example under the Acclaim® and Desmophen® trade names from Covestro, especially Acclaim® 4200, Desmophen® 5034, Desmophen® 1381 BT, and Desmophen® 28HS98, under the Voranol® trade name from Dow, especially Voranol® EP 1900 and Voranol® CP 4755, and under the under the Dianol® trade name from Arkema, especially Dianol® 3130 HP.

Suitable polyester polyols include in particular polyesters that bear at least two hydroxyl groups and are produced by known processes, especially polycondensation of hydroxycarboxylic acids or polycondensation of aliphatic and/or aromatic polycarboxylic acids with dihydric or polyhydric alcohols. Especially suitable are polyester polyols produced from dihydric to trihydric alcohols, for example ethane-1,2-diol, diethylene glycol, propane-1,2-diol, dipropylene glycol, or mixtures of the abovementioned alcohols with organic dicarboxylic acids or the anhydrides or esters thereof, for example succinic acid, glutaric acid, adipic acid, trimethyladipic acid, maleic acid, fumaric acid, phthalic acid, phthalic anhydride, isophthalic acid, terephthalic acid, dimethyl terephthalate, hexahydrophthalic acid, trimellitic acid and trimellitic anhydride or mixtures of the abovementioned acids, as are polyester polyols formed from lactones such as ε-caprolactone.

Particularly suitable are hydrophilic polyester diols, especially those produced from adipic acid, phthalic acid, isophthalic acid, and terephthalic acid as the dicarboxylic acid or from lactones such as E-caprolactone and from ethylene glycol, diethylene glycol, neopentyl glycol, butane-1,4-diol, hexane-1,6-diol, and cyclohexane-1,4-dimethanol as the dihydric alcohol.

Examples of suitable polyester polyols are those obtainable under the Kuraray® trade name from Kuraray, especially Kuraray® F-510, and those obtainable under the K-Flex® trade name from King Industries, especially K-Flex® 188.

Particularly suitable polyols P2 are polyether polyols, selected in particular from the list consisting of polyoxyethylene polyol, polyoxypropylene polyol, and polyoxypropylene polyoxyethylene polyol, preferably polyoxyethylene diol, polyoxypropylene diol, polyoxyethylene triol, polyoxypropylene triol, polyoxypropylene polyoxyethylene diol, and polyoxypropylene polyoxyethylene triol, most preferably polyoxypropylene triol.

Most preferably, polyol P2 is a polyether polyol, especially a polyether polyol having an average OH functionality of at least 2.5, and preferably having propylene glycol repeat units in the polymer backbone.

Preferably the weight ratio of polyol P1 to polyol P2 ((P1)/(P2)) is from 3 to 10, preferably 5 to 9, most preferably 6 to 8. A ratio of less than 3 results in lower elongation values, a ratio of more than 10 results in lower mechanical properties and toughness.

Preferably, the sum total of polyol P1 and polyol P2 is more than 75% by weight, preferably than 80% by weight, than 90% by weight, than 95% by weight, especially than 98% by weight, of the polyol mixture P.

The polyol mixture P preferably comprises more than 80% by weight, more than 90% by weight, especially more than 95% by weight, of the total amount of NCO-reactive groups in the polyurethane composition.

The second component B comprises at least one aliphatic polyisocyanate I.

An “aliphatic isocyanate” refers to an isocyanate in which the isocyanate groups are directly attached to an aliphatic carbon atom. Such isocyanate groups are accordingly referred to as “aliphatic isocyanate groups”.

Suitable aliphatic polyisocyanates I are in particular monomeric di- or triisocyanates and also oligomers, polymers, and derivatives of monomeric di- or triisocyanates, and any desired mixtures thereof.

Preferred aliphatic monomeric polyisocyanates are aliphatic or cycloaliphatic diisocyanates, especially HDI, TMDI, cyclohexane 1,3-diisocyanate or 1,4-diisocyanate, IPDI, H₁₂MDI, 1,3- or 1,4-bis(isocyanatomethyl) cyclohexane, and XDI.

A particularly preferred monomeric polyisocyanate is HDI, IPDI, TDI or H₁₂MDI. Most preferred is HDI or IPDI, especially HDI.

Suitable oligomers, polymers, and derivatives of the monomeric di- and triisocyanates mentioned are especially those derived from HDI or IPDI, especially HDI. Among these, commercially available products are especially suitable, for example Desmodur® N 75, Desmodur® N 3600, and Desmodur® N 3900 (all from Covestro). They preferably have an NCO content of 16% to 24% by weight, preferably 20% to 24% by weight.

Particularly preferred aliphatic polyisocyanates are oligomers, polymers, and derivatives derived from HDI or IPDI, especially HDI. They preferably have an NCO content of 16% to 24% by weight, preferably 20% to 24% by weight.

It is further advantageous when the sum of the NCO groups that do not originate from aliphatic polyisocyanate I is ≤20%, especially ≤10%, especially preferably ≤5%, most preferably ≤1%, based on the sum of all NCO groups in the polyurethane composition.

The proportion of the aliphatic polyisocyanate I is preferably ≥90% by weight, especially ≥95% by weight, especially preferably ≥99% by weight, based on the total weight of the second component.

Preferably, the polyurethane composition has a proportion of aromatic polyisocyanates of less than 5% by weight, less than 2% by weight, less than 1% by weight, less than 0.5% by weight, less than 0.1% by weight, based on the total weight of the polyurethane composition. Aromatic polyisocyanates are disadvantageous in that the pot life is greatly reduced and the cured polyurethane composition tends to undergo yellowing.

Preferably, the polyurethane composition has a proportion of polyaspartic esters of less than 15% by weight, of less than 10% by weight, of less than 5% by weight, less than 2% by weight, less than 1% by weight, less than 0.5% by weight, less than 0.1% by weight, based on the total weight of the polyurethane composition. Polyaspartic esters are disadvantageous in that the curing reaction proceeds too quickly, especially at high humidity.

The weight ratio of component (A) to component (B) is preferably 5:1 to 2:1, more preferably 4:1 to 3:1.

The molar ratio between free NCO groups and NCO-reactive groups, preferably OH groups, in the composition according to the invention is before mixing preferably between 0.8-1.2, preferably 0.9-1.1, especially 0.95-1.05.

The polyurethane composition additionally contains 5% by weight to 70% by weight of at least one filler F, based on the total weight of the polyurethane composition. The filler F may be present in the first component A or in the second component B, more particularly it is present in the first component A.

Fillers are preferably selected from the list consisting of ground or precipitated calcium carbonates that have optionally been coated with fatty acids, especially stearates, barytes, quartz powders, quartz sands, titanium dioxide, dolomites, wollastonites, kaolins, calcined kaolins, phyllosilicates, such as mica or talc, zeolites, aluminum hydroxides, magnesium hydroxides, silicas, including finely divided silicas from pyrolysis processes, cements, gypsums, fly ashes, industrially produced carbon blacks, graphite, metal powders, for example of aluminum, copper, iron, silver or steel, PVC powders or hollow beads. The polyurethane composition preferably comprises at least one filler F selected from the group consisting of aluminum hydroxides, titanium dioxide, calcium carbonate, carbon black, quartz sand, kaolin, baryte, talc, quartz powder, dolomite, wollastonite, kaolin, calcined kaolin, and mica.

Particularly preferred fillers are fillers F selected from the list consisting of aluminum hydroxides, titanium dioxide, ground calcium carbonates, calcined kaolins, quartz sands and baryte.

It may be advantageous to use a mixture of different fillers. Most preferred are combinations of ground aluminum hydroxides and titanium dioxide.

The particle size of the fillers F is preferably 0.1 to 50 μm, more preferably 1 to 30 μm.

The proportion of fillers F is preferably 10-55% by weight, 15-50% by weight, 20-50% by weight, 25-45% by weight, especially 30-40% by weight, based on the total weight of the polyurethane composition.

The polyurethane composition additionally comprises at least one tin catalyst K for the reaction of hydroxyl groups and isocyanate groups that is capable of forming thio complexes.

The tin catalyst K is preferably an organotin compound, especially an organotin (IV) compound.

In particular, it is a tin catalyst K selected from the list consisting of dibutyltin diacetate, dibutyltin dilaurate, dibutyltin dichloride, dibutyltin diacetylacetonate, dimethyltin dilaurate, dioctyltin diacetate, dioctyltin dilaurate, dioctyltin diacetylacetonate, dioctyltin dineodecanoate, bis[(2-ethyl-1-oxohexyl)oxy]dioctylstannane, bis(neodecanoyloxy)dioctylstannane, bis(dodecylthio)dioctylstannane, and bis(dodecylthio)dimethylstannane. In particular, it is dibutyltin dilaurate, dioctyltin diacetylacetonate, dioctyltin dineodecanoate or bis(dodecylthio)dioctylstannane, particularly preferably dioctyltin dineodecanoate.

It may be advantageous if the tin catalyst K is present only in the first component A.

Particularly preferably, some of the tin catalyst K is present in a third component C that is not the first component A or the second component B. Preferably 20% by weight to 70% by weight, especially 30% by weight to 60% by weight, more preferably 40% by weight to 50% by weight, of the tin catalyst K, based on the total amount of tin catalyst K in the polyurethane composition, is present in the third component C. This has the advantage of achieving better storage stability.

The amount of tin catalyst K, based on the overall polyurethane composition, is preferably within a range of from 0.8% to 1.5% by weight, preferably 0.9% to 1.4% by weight, more preferably 1.0% to 1.3% by weight, based on the overall polyurethane composition.

Preferably, the polyurethane composition has a proportion of less than 0.5% by weight, less than 0.1% by weight, less than 0.05% by weight, less than 0.01% by weight, less than 0.001% by weight, based on the total weight of the polyurethane composition, of catalysts for the reaction of hydroxyl groups and isocyanate groups that are not the tin catalysts K mentioned above. In particular, these are metal catalysts, especially bismuth, zinc or zirconium compounds, including complexes and salts of these metals, preferably complex compounds of bismuth (III) or zirconium (IV), especially with ligands selected from alkoxides, carboxylates, 1,3-diketonates, oxinate, 1,3-ketoesterates, and 1,3-ketoamidates, or compounds containing tertiary amino groups, such as in particular 2,2′-dimorpholinodiethyl ether (DMDEE).

The polyurethane composition additionally comprises at least one compound T that has at least one thiol group. A thiol group is understood here as meaning an —SH group that is attached to an organic radical, for example an aliphatic, cycloaliphatic or aromatic carbon radical.

Preference is given to compounds having 1 to 6, especially 2 to 4, most preferably 2 or 3, thiol groups.

Examples of suitable compounds T having a thiol group are 3-mercaptopropyltrimethoxysilane, 3-mercaptopropyltriethoxysilane, 3-mercaptopropane-1,2-diol, 2-mercaptotoluimidazole or 2-mercaptobenzothiazole.

Suitable compounds T having more than one thiol group are preferably selected from the list consisting of ethylene glycol di(3-mercaptopropionate), ethylene glycol dimercaptoacetate, dipentaerythritol hexa (3-mercaptopropionate), trimethylolpropane tris(3-mercaptopropionate), 2,3-dimercapto-1,3,4-thiadiazole, pentaerythritol tetrakis(3-mercaptopropionate), and 3,6-dioxa-1,8-octanedithiol.

The compound T is preferably selected from the group consisting of ethylene glycol di(3-mercaptopropionate), ethylene glycol dimercaptoacetate, and dipentaerythritol hexa (3-mercaptopropionate), most preferably ethylene glycol di(3-mercaptopropionate).

The amount of compound T, based on the overall polyurethane composition, is preferably within a range of from 0.50% to 1.00% by weight, preferably 0.60% to 0.90% by weight, especially 0.70% to 0.80% by weight, based on the total polyurethane composition.

Preferably, the compound T is present only in a third component C. The third component C is preferably the abovementioned component C preferably comprising the mentioned tin catalyst K. This has the advantage of achieving better storage stability.

Most preferably, the entirety of compound T and 20% by weight to 70% by weight, especially 30% by weight to 60% by weight, more preferably 40% by weight to 50% by weight, of the tin catalyst K, based on the total amount of tin catalyst K in the polyurethane composition, are present in the third component C.

The molar ratio of all thiol groups in the at least one compound T to all metal atoms in the at least one tin catalyst K (T/K) is from 2.75:1 to 10:1.

The molar ratio (T/K) is preferably 3:1 to 7.5:1, especially 3.5:1 to 5:1, most preferably 3.5:1 to 4:1.

A molar ratio (T/K) of less than 2.75 results in a pot life that is too short, especially at temperatures of 21° C. and 90% relative humidity. This can be seen for example in Table 2 comparing Ex. 1-3 with Ref. 1 to Ref. 4. The abovementioned preferred molar ratios (T/K) are advantageous in that it is possible to achieve a particularly good ratio of particularly preferred pot life to particularly preferred curing time. This can be seen for example in Table 2 comparing Ex. 2 with Ex. 1 and Ex. 3. A molar ratio of greater than 10:1 is disadvantageous in that it results in polyurethane compositions being obtained that, especially when cured at 5° C. and 90% relative humidity, have curing times of more than 4 hours and tend to have surfaces that remain tacky for a long time.

The molar ratio of all NCO groups in the polyurethane composition to all metal atoms in the at least one tin catalyst K (NCO/K) is preferably from 20 to 200.

More particularly, the molar ratio (NCO/K) is 50 to 125, preferably 60 to 100, most preferably 65 to 85.

The abovementioned preferred molar ratios (NCO/K) are advantageous in that it is possible to achieve a particularly good ratio of particularly preferred pot life to particularly preferred curing time. This can be seen for example in Table 2 comparing Ex. 2 with Ex. 1 and Ex. 3.

The polyurethane composition comprises 0.7 to 2.9 mM, based on 100 g of the polyurethane composition, of at least one acid SA having a pKₐ of ≤4.9. The at least one acid SA can be used as free acids or in blocked form, preferably free acids are used.

It is advantageous when the at least one acid SA has a pKₐ of ≤3, preferably a pKₐ of ≤1, especially a pKₐ of ≤0. A pKₐ of ≤4.9 results in a sufficiently long pot life in conjunction with a sufficiently short curing time. This can be seen for example in Table 3 comparing Ex. 2 with Ref. 8 to Ref. 11.

Preferably the proportion of the at least one acid SA is 0.8 to 2.0 mM, preferably 0.9 to 1.5 mM, more preferably 0.9 to 1.25 mM, based on 100 g of the polyurethane composition. This has the advantage that it is possible to achieve a particularly good ratio of particularly preferred pot life to particularly preferred curing time. This can be seen for example in Table 3 comparing Ex. 2 with Ref. 5 to Ref. 7.

The at least one acid SA having a pKₐ of ≤4.9 is preferably monobasic or polybasic, especially monobasic, organic or inorganic, preferably organic, acids, especially preferably organic sulfonic acids.

Preferred inorganic acids are selected from the group consisting of sulfuric acid, pyrophosphoric acid, sulfurous acid, tetrafluoroboric acid, trichloroacetic acid, dichloroacetic acid, oxalic acid, nitroacetic acid.

The at least one acid SA is more preferably selected from the group consisting of methanesulfonic acid, para-toluenesulfonic acid, benzenesulfonic acid, dodecyl benzenesulfonic acid, cyclododecanesulfonic acid and camphorsulfonic acid, most preferably benzenesulfonic acid.

Preferably, the polyurethane composition has a proportion of organic solvents, especially organic solvents having a boiling point at 23° C. of less than 200° C., of less than 10% by weight, less than 7.5% by weight, preferably less than 5% by weight, based on the total weight of the polyurethane composition. Said organic solvents are especially organic solvents selected from the list consisting of acetone, methyl ethyl ketone, methyl n-propyl ketone, diisobutyl ketone, methyl isobutyl ketone, methyl n-amyl ketone, methyl isoamyl ketone, acetylacetone, mesityl oxide, cyclohexanone, methylcyclohexanone, ethyl acetate, propyl acetate, butyl acetate, n-butyl propionate, diethyl malonate, 1-methoxy-2-propyl acetate, ethyl 3-ethoxypropionate, diisopropyl ether, diethyl ether, dibutyl ether, diethylene glycol diethyl ether, ethylene glycol diethyl ether, ethylene glycol monopropyl ether, ethylene glycol mono (2-ethylhexyl) ether, acetals such as in particular methylal, ethylal, propylal, butylal, 2-ethylhexylal, dioxolane, glycerol formal or 2,5,7,10-tetraoxaundecane (TOU), toluene, xylene, heptane, octane, naphtha, white spirit, petroleum ether or petroleum spirit, methylene chloride, propylene carbonate, butyrolactone, N-methylpyrrolidone, and N-ethylpyrrolidone.

It can also be advantageous when the polyurethane composition has a proportion of the abovementioned plasticizers of less than 5% by weight, of less than 2% by weight, less than 1% by weight, less than 0.5% by weight, less than 0.1% by weight, based on the total weight of the polyurethane composition.

Such plasticizers are selected in particular from the list consisting of carboxylic esters such as phthalates, especially diisononyl phthalate (DINP), diisodecyl phthalate (DIDP) or di(2-propylheptyl) phthalate (DPHP), hydrogenated phthalates, especially hydrogenated diisononyl phthalate or diisononyl cyclohexane-1,2-dicarboxylate (DINCH), terephthalates, especially dioctyl terephthalate, trimellitates, adipates, especially dioctyl adipate, azelates, sebacates, benzoates, glycol ethers, glycol esters, organic phosphoric or sulfonic acid esters, polybutenes, and polyisobutenes.

The composition may comprise further additives commonly used for polyurethane compositions. More particularly, the following auxiliaries and additives may be present:
inorganic or organic pigments, especially chromium oxides or iron oxides;
fibers;
adhesion promoters;
rheology modifiers;
flame-retardant substances;
additives, especially wetting agents, leveling agents, defoamers, deaerators, stabilizers against oxidation, heat, light or UV radiation, or biocides;
   or further substances customarily used in such compositions.

The polyurethane composition contains preferably less than 0.5% by weight, especially less than 0.1% by weight, less than 0.01% by weight, more preferably less than 0.001% by weight, based on the overall composition, of a tertiary acid of formula RR′R″CCOOH, where each R, R′, and R″ group is independently an alkyl, alkenyl, aryl or aralkyl group containing at least one carbon atom, with the proviso that two or three of the R, R′ and R″ groups may be connected to form a ring structure, and where the groups R, R′, and/or R″ may be substituted and where the total number of carbon atoms in the groups R, R′ and R″ is within a range of from 3 to 40.

A preferred polyurethane composition comprises a first component A and a second component B, wherein
the first component A comprises
   a polyol mixture P, comprising
      at least one polyol P1 having an average molecular weight of 800 to 30 000 g/mol, preferably 850 to 20 000 g/mol, more preferably 900 to 10 000 g/mol, wherein the polyol P1 is castor oil or a chemical modification thereof, especially a chemical modification of castor oil, more preferably a reaction product of castor oil with ketone resins, preferably a polyol having an OH value of 110 to 200 mg KOH/g, 140 to 190 mg KOH/g, especially 140 to 170 mg KOH/g, more preferably 150 to 170 mg KOH/g; and
      preferably at least one polyol P2 selected from the group consisting of polyester polyols and polyether polyols, preferably polyether polyols, especially preferably polyoxyethylene polyols, polyoxypropylene polyols, and polyoxypropylene polyoxyethylene polyols, especially polyols having an average molecular weight within a range of from 400 to 6000 g/mol, especially 450 to 5500 g/mol, more preferably 500 to 5000 g/mol, 750 to 3000 g/mol, most preferably 1000 to 2000 g/mol, preferably polyols having an average OH functionality within a range of from 2 to 4, especially 2 to 3.5, more preferably 2 to 3;
      wherein the weight ratio of polyol P1 to polyol P2 ((P1)/(P2)) is preferably from 3 to 10, preferably 5 to 9, most preferably 6 to 8; and
the second component B comprises
   at least one aliphatic polyisocyanate I, especially oligomers, polymers, and derivatives derived from HDI or IPDI, especially HDI, especially having an NCO content of from 16% to 24% by weight, preferably 20% to 24% by weight.

The preferred polyurethane composition further comprises:
5% by weight to 70% by weight, 10-55% by weight, 15-50% by weight, 20-50% by weight, 25-45% by weight, especially 30-40% by weight, of at least one filler F, based on the total weight of the polyurethane composition, selected in particular from the group consisting of aluminum hydroxides, titanium dioxide, ground calcium carbonates, calcined kaolins, quartz sands and baryte; and
at least one tin catalyst K for the reaction of hydroxyl groups and isocyanate groups that is capable of forming thio complexes, especially an organotin compound, especially an organotin (IV) compound; and
at least one compound T having at least one thiol group, especially 2 to 4, most preferably 2 or 3, thiol groups, selected in particular from the list consisting of ethylene glycol di(3-mercaptopropionate), ethylene glycol dimercaptoacetate, dipentaerythritol hexa (3-mercaptopropionate), trimethylolpropane tris(3-mercaptopropionate), 2,3-dimercapto-1,3,4-thiadiazole, pentaerythritol tetrakis(3-mercaptopropionate), and 3,6-dioxa-1,8-octanedithiol; and
the molar ratio of all thiol groups in the at least one compound T to all metal atoms in the at least one tin catalyst K (T/K) is from 2.75:1 to 10:1, especially 3:1 to 7.5:1, especially 3.5:1 to 5:1, most preferably 3.5:1 to 4:1; and
the molar ratio of all NCO groups in the polyurethane composition to all metal atoms in the at least one tin catalyst K (NCO/K) is from preferably 20 to 200, 50 to 125, preferably 60 to 100, most preferably 65 to 85.

The molar ratio between free NCO groups and NCO-reactive groups, preferably OH groups, in the preferred composition is before mixing preferably between 0.8-1.2, preferably 0.9-1.1, especially 0.95-1.05.

Preferably, the preferred polyurethane composition has a proportion of organic solvents, especially organic solvents having a boiling point at 23° C. of less than 200° C., of less than 10% by weight, less than 7.5% by weight, less than 5% by weight.

Preferably, the sum total of polyol P1 and polyol P2 in the preferred polyurethane composition is more than 75% by weight, preferably than 80% by weight, than 90% by weight, than 95% by weight, especially than 98% by weight, of the polyol mixture P.

The polyol mixture P preferably comprises more than 80% by weight, especially more than 90% by weight, more than 95% by weight, of the total amount of NCO-reactive groups in the preferred polyurethane composition.

The proportion of the aliphatic polyisocyanate I in the preferred polyurethane composition is preferably ≥90% by weight, especially ≥95% by weight, especially preferably ≥99% by weight, based on the total weight of the second component.

Particularly preferably, the compound T is in the preferred polyurethane composition present only in a third component C that is not the first component A or the second component B, preferably additionally 20% by weight to 70% by weight of the tin catalyst K, based on the total amount of tin catalyst K in the polyurethane composition, is present in the third component C.

The two components A and B are produced separately and preferably with the exclusion of moisture. The two components are typically each stored in a separate container. The further constituents of the polyurethane composition may be present as a constituent of the first or second component, further constituents that are reactive toward isocyanate groups preferably being a constituent of the first component. A suitable container for storing the respective component is especially a drum, a hobbock, a bag, a bucket, a can, a cartridge or a tube. The components are both storage-stable, meaning that they can be stored prior to use for several months up to one year or longer without any change in their respective properties to a degree relevant to their use.

The two components are stored separately prior to the mixing of the composition and are not mixed with one another until use or just before use. They are advantageously present in a package consisting of two separate chambers.

In further aspect, the invention comprises a pack containing the polyurethane composition according to the invention, consisting of a package having at least two, especially at least three, preferably three or four, most preferably three, separate chambers respectively containing the first component A, the second component B, and preferably the abovementioned third component C, of the polyurethane composition.

Particularly preferred is a pack consisting of a package consisting of the above-described first component A, second component B, and third component C. The third component C comprises in particular the abovementioned compound T. The compound T is preferably present only in the third component C and preferably additionally 20% by weight to 70% by weight of the tin catalyst K, based on the total amount of tin catalyst K in the polyurethane composition, is present in the third component C.

Mixing is typically effected using a hand mixer. When mixing, care must be taken to ensure that the first component A and the second component B are mixed as homogeneously as possible. If the two components are mixed incompletely, local deviations from the advantageous mixing ratio will occur, which can result in a deterioration in the mechanical properties.

On contact of the first component A with the second component B, curing commences through chemical reaction. This involves the reaction with the isocyanate groups of the hydroxyl groups and any other substances present that are reactive toward isocyanate groups. Excess isocyanate groups react predominantly with moisture. As a result of these reactions, the polyurethane composition cures to give a solid material. This process is also referred to as crosslinking.

The invention thus also further provides a cured polyurethane composition obtained from the curing of the polyurethane composition as described in the present document.

The invention thus relates also to a process for producing a building waterproofing system, especially a roof waterproofing system, using the polyurethane composition of the invention, the process comprising:
a) mixing of the first component (A) and the second component (B), and also the at least one filler F, the at least one tin catalyst K, and the at least one compound T,
b) applying the mixed material to a substrate,
c) optionally smoothing the applied mixed material, and
d) curing the applied mixed material to obtain a building waterproofing system, especially a roof waterproofing system.

The first component (A), second component (B), filler F, tin catalyst K, and compound T described in step a) are preferably the same as in the embodiments identified above as being preferred. In step a), a mixture of the polyurethane composition according to the invention is particularly preferably formed, especially a polyurethane composition identified above as being particularly preferred.

It is preferable that steps a) to d) take place in this exact chronological order.

It is further advantageous when steps a) to d) are carried out within a temperature range of from 5° C. to 21° C., preferably 5° C. to 15° C., especially 5° C. to 10° C., especially preferably 4° C. to 8° C. Preference is given to using in step a) an above-described pack consisting of a package consisting of the above-described first component A, second component B, and optional third component C.

In a preferred embodiment, the process is used to produce a balcony waterproofing system or a roof waterproofing system in multistorey buildings, especially in buildings having more than 10 storeys.

Preferred substrates to which the polyurethane composition can be applied are selected from the list consisting of concrete, brick, stone, asphalt, bitumen and metal, especially concrete.

Preferably the substrate is a pretreated substrate, preferably pretreated with a polyurethane primer or an epoxy resin primer. This primer preferably has a thickness of 0.1-1 mm, especially 0.3-0.7 mm.

The polyurethane composition can be applied by any standard process, especially coating, pouring, casting or troweling. The building waterproofing system obtained, especially the balcony waterproofing system or roof waterproofing system, preferably has a thickness of 0.1-10 mm, 0.5-10 mm, especially 1-8 mm, 1.5-6 mm, 1.5-4 mm, more preferably 1.5-3 mm.

The application temperature for the polyurethane composition is preferably 5° C. to 21° C., preferably 5° C. to 15° C., especially 5° C. to 10° C., especially preferably 4° C. to 8° C.

The invention relates also to the floor covering, preferably a building waterproofing system, especially a balcony waterproofing system or a roof waterproofing system, especially a roof waterproofing system in multistorey buildings, particularly preferably in buildings having more than 10 storeys, obtainable by the process according to the invention. The invention relates also to the use of the polyurethane composition as a building waterproofing system, especially a balcony waterproofing system or a roof waterproofing system.

The invention further relates to the use of the polyurethane composition according to the invention for producing the building waterproofing systems, especially balcony waterproofing systems or roof waterproofing systems, described above.

The polyurethane composition preferably has the following properties across the entire temperature range (at 90% relative humidity) from 5° C. to 21° C.:
pot life, especially measured as described in the experimental section: 15 min-45 min, especially 15-32 min, especially 16-25 min;
curing time, especially measured as described in the experimental section: 60 min-220 min, especially 60 min-205.

### EXAMPLES

### Substances Used:

TABLE 1
Substances used.

| P1 | Reaction product of castor oil with ketone resin, OH |
|---|---|
| | value of 150-190 mg KOH/g |
| P2 | Polyoxypropylene triol, hydroxyl value: 350-600 mg KOH/g |
| P3 | Polyoxypropylene triol, hydroxyl value: 26-30 mg KOH/g |
| Molecular | Sylosiv ® A3 |
| sieve | |
| Filler | Mixture of titanium dioxide and aluminum hydroxide |
| Additives | Mixture of defoamers (proportion 12% by weight), dispersing |
| | agents (proportion 8% by weight) and aprotic solvents |
| | (proportion 80% by weight) |
| HDI | HDI trimer containing 70% trimer and smaller amounts of |
| | higher oligomers, total NCO functionality = 3.1, equivalent |
| | weight 183 g/mol, NCO content 22.5-23.5% by weight, |
| | Tolonate HDT-LV (VENCOREX) |
| IPDI | IPDI trimer (70% in Solvent Naphtha 100), NCO content |
| | 11.9% by weight, Desmodur Z 4470 SN (Covestra) |
| GDMP | Thiocure ® 320 (Bruno Bock Thiochemicals); |
| | glycol di(3-mercaptopropionate), |
| | molecular weight 238.3 g/mol, 2-functional. |
| Acid 1 | Benzenesulfonic acid, Mw: 158.18 g/mol, CAS number: 98- |
| | 11-3, pKₐ: −2.8, SASOL Germany GmbH |
| Acid 2 | Oleic acid ((9Z)-octadec-9-enoic acid), Mw: 282.46 g/mol, |
| | CAS number: 112-80-1, pKₐ: 5.02, Samuel Banner & Co. Ltd |
| TIB Kat | Dioctyltin dineodecanoate, TIB Kat 318 |
| 318 | |

### Preparation of Polyurethane Compositions and Measurement Methods

For each composition, the ingredients of the first component A specified in Tables 2 and 3, in the specified amounts (in parts by weight (wt.-%)), were processed using a vacuum dissolver with the exclusion of moisture into a homogeneous mixture and stored. The ingredients of the second component B, respectively component C, specified in the tables were likewise processed and stored. The molar ratio between free NCO groups and NCO-reactive groups was 1.05 (NCO/OH). The examples Ex. 1 to Ex. 3 are compositions according to the invention and the examples Ref. 1 to Ref. 11 are comparative examples.

For determination of the pot life (TZ), the reaction curve at 5° C., 10° C. and at 21° C., in each case at 90% relative humidity (r.h), was determined. For this, components A, B and C were thermally equilibrated at the temperature and relative humidity specified in Tables 2 and 3. The components in the appropriate mixing ratio are using a Speed Mixer™ DAC 150.1 FVZKPG for 60 seconds at 2000 rpm. At the start of mixing, the time measurement begins and the temperature measurement is carried out by means of a Pt-100 resistance thermometer placed in the middle of the mixed composition.

After the three components have been mixed, the crosslinking reaction commences. This is manifested in the rise in viscosity and increase in temperature. The pot life is the time taken to reach the critical temperature or a significant change in the temperature rise. To determine the reactivity, the rate at which a sample reaches its maximum temperature Tₘₐₓ is measured. The temperature curve allows a comparative assessment of reaction resin masses in respect of their reactivity.

The maximum temperature reached (Tₘₐₓ) and the time taken to reach T=50° C. can be read from the temperature curve. The pot life is determined graphically from the recorded temperature-time plot. The measured values are determined as the perpendicular to the time axis of the points of vertical intersection of the first change in the slope of the temperature-time curve. The position of the intercept on the time axis gives the pot life in minutes.

To determine the curing time (AZ), a 1 mm thick film of the blended composition was poured onto a hard surface and the time until it was tack free was determined according to DIN 53 150 and DIN ES ISO 1517 using a “Drying Time Tester Model 415” from Erichsen. The curing time of the poured film was determined periodically over the time by applying a load of 2 kg perpendicularly to a sheet of filter paper placed over the surface of the coating. The curing time was determined as the time in which the paper, with subsequent application of a 2 kilo load, did not adhere to the coating and no visible signs of change were present on the coated surface, based on test standard DIN 53 150 (degree of drying 4).

TABLE 2

| | | Ref. 1 | Ref. 2 | Ref. 3 | Ex. 1 | Ex. 2 | Ex. 3 | Ref. 4 |
|---|---|---|---|---|---|---|---|---|
| Comp. A | | | | | | | | |
| P1 | | 30.394 | 30.38 | 30.364 | 29.768 | 29.723 | 29.678 | 30.900 |
| P2 | | 4.122 | 4.12 | 4.118 | 4.037 | 4.031 | 4.025 | 4.191 |
| Fillers | | 32.362 | 32.341 | 32.321 | 30.82 | 30.751 | 30.692 | 33.03 |
| Additives | | 6 | 6 | 6 | 6 | 6 | 6 | 6 |
| Molecular | | 1.5 | 1.5 | 1.5 | 1.5 | 1.5 | 1.5 | 1.5 |
| sieve | | | | | | | | |
| Acid 1 | | 0.15 | 0.15 | 0.15 | 0.15 | 0.15 | 0.15 | 0.15 |
| Tib Kat | | 0.100 | 0.150 | 0.200 | 0.500 | 0.650 | 0.800 | 0.675 |
| 318 | | | | | | | | |
| Comp. C | | | | | | | | |
| GDMP | | 0.311 | 0.311 | 0.311 | 0.726 | 0.726 | 0.726 | 0 |
| P3 | | 1.141 | 1.141 | 1.141 | 1.723 | 1.723 | 1.723 | 0 |
| Tib Kat | | 0.622 | 0.622 | 0.622 | 0.484 | 0.484 | 0.484 | 0.502 |
| 318 | | | | | | | | |
| Comp. B | | | | | 0.726 | 0.726 | 0.726 | |
| HDI | | 21.113 | 21.102 | 21.092 | 21.355 | 21.323 | 21.291 | 20.892 |
| IPDI | | 2.184 | 2.183 | 2.182 | 2.217 | 2.214 | 2.21 | 2.16 |
| Total (% | | 100 | 100 | 100 | 100 | 100 | 100 | 100 |
| by weight) | | | | | | | | |
| NCO/OH | | 1.05 | 1.05 | 1.05 | 1.05 | 1.05 | 1.05 | 1.05 |
| T/K | | 2.5 | 2.3 | 2.2 | 4.3 | 3.7 | 3.3 | 0.0 |
| NCO/K | | 116.0 | 108.4 | 101.8 | 86.1 | 74.7 | 65.9 | 70.4 |
| TZ | 5° C./90% | 25 | 23 | 20 | 32 | 25 | 21 | 2 |
| AZ | r.h (min) | 192 | 187 | 180 | 205 | 191 | 183 | 140 |
| TZ | 10° C./90% | 22 | 20 | 18 | 27 | 22 | 18 | 2 |
| AZ | r.h (min) | 141 | 136 | 131 | 149 | 139 | 132 | 105 |
| TZ | 21° C./90% | 14 | 12 | 11 | 18 | 16 | 15 | 1 |
| AZ | r.h (min) | 68 | 65 | 62 | 66 | 63 | 60 | 58 |

TABLE 3

| | | Ref. 5 | Ref. 6 | Ex. 2 | Ref. 7 | Ref. 8 | Ref. 9 | Ref. 10 | Ref. 11 |
|---|---|---|---|---|---|---|---|---|---|
| Comp. A | | | | | | | | | |
| P1 | | 29.723 | 29.723 | 29.723 | 29.723 | 29.723 | 29.723 | 29.723 | 29.723 |
| P2 | | 4.031 | 4.031 | 4.031 | 4.031 | 4.031 | 4.031 | 4.031 | 4.031 |
| Fillers | | 31.581 | 31.531 | 30.751 | 30.404 | 31.531 | 31.431 | 31.231 | 31.131 |
| Additives | | 6 | 6 | 6 | 6 | 6 | 6 | 6 | 6 |
| Molecular | | 1.5 | 1.5 | 1.5 | 1.5 | 1.5 | 1.5 | 1.5 | 1.5 |
| sieve | | | | | | | | | |
| Acid 1 | | 0.05 | 0.1 | 0.15 | 0.5 | | | | |
| Acid 2 | | | | | | 0.1 | 0.2 | 0.4 | 0.5 |
| Tib Kat | | 0.650 | 0.650 | 0.650 | 0.650 | 0.650 | 0.650 | 0.650 | 0.650 |
| 318 | | | | | | | | | |
| Comp. C | | | | | | | | | |
| GDMP | | 0.725 | 0.725 | 0.726 | 0.725 | 0.725 | 0.725 | 0.725 | 0.725 |
| P3 | | 1.721 | 1.721 | 1.723 | 1.721 | 1.721 | 1.721 | 1.721 | 1.721 |
| Tib Kat | | 0.483 | 0.483 | 0.484 | 0.483 | 0.483 | 0.483 | 0.483 | 0.483 |
| 318 | | | | | | | | | |
| Comp. B | | | | 0.726 | 0.726 | | | | |
| HDI | | 21.323 | 21.323 | 21.323 | 21.323 | 21.323 | 21.323 | 21.323 | 21.323 |
| IPDI | | 2.214 | 2.214 | 2.214 | 2.214 | 2.214 | 2.214 | 2.214 | 2.214 |
| Total (% | | 100 | 100 | 100 | 100 | 100 | 100 | 100 | 100 |
| by weight) | | | | | | | | | |
| NCO/OH | | 1.05 | 1.05 | 1.05 | 1.05 | 1.05 | 1.05 | 1.05 | 1.05 |
| mM Acid/ | | 0.32 | 0.63 | 0.95 | 3.16 | 0.35 | 0.71 | 1.42 | 1.77 |
| 100 g | | | | | | | | | |
| T/K | | 3.7 | 3.7 | 3.7 | 3.7 | 3.7 | 3.7 | 3.7 | 3.7 |
| NCO/K | | 74.7 | 74.7 | 74.7 | 74.7 | 74.7 | 74.7 | 74.7 | 74.7 |
| TZ | 5° C./90% | 15 | 19 | 25 | 38 | 15 | 18 | 29 | 39 |
| AZ | r.h (min) | 163 | 179 | 191 | 242 | 160 | 184 | 232 | 245 |
| TZ | 10° C./90% | 11 | 16 | 22 | 31 | 12 | 13 | 20 | 28 |
| AZ | r.h (min) | 114 | 121 | 139 | 196 | 115 | 124 | 165 | 172 |
| TZ | 21° C./90% | 6 | 10 | 16 | 26 | 7 | 8 | 14 | 15 |
| AZ | r.h (min) | 50 | 57 | 63 | 89 | 50 | 55 | 60 | 68 |

1. A polyurethane composition comprising a first component A and a second component B, wherein
the first component A comprises
a polyol mixture P, comprising
at least one polyol P1 having an average molecular weight of 800 to 30 000 g/mol, wherein the polyol P1
is a polyhydroxy-functional fat and/or a polyhydroxy-functional oil, or a polyol obtained by chemically modifying natural fats and/or natural oils; and
optionally at least one polyol P2 selected from the group consisting of polyester polyols and polyether polyols; and
the second component B comprises
at least one aliphatic polyisocyanate I;
wherein the polyurethane composition additionally contains 5% by weight to 70% by weight, of at least one filler F, based on the total weight of the polyurethane composition,
and wherein the polyurethane composition additionally contains
0.7-2.9 mM, based on 100 g of the polyurethane composition, of at least one acid SA having a pKₐ of ≤4.9,
and at least one tin catalyst K for the reaction of hydroxyl groups and isocyanate groups that is capable of forming thio complexes, and at least one compound T having at least one thiol group, the molar ratio of all thiol groups in the at least one compound T to all metal atoms in the at least one tin catalyst K (T/K) being from 2.75:1 to 10:1 and the molar ratio of all NCO groups in the polyurethane composition to all metal atoms in the at least one tin catalyst K (NCO/K) being from 20 to 200.

2. The polyurethane composition as claimed in claim 1, wherein the polyol P1 is castor oil or a chemical modification thereof.

3. The polyurethane composition as claimed in claim 1, wherein the polyol P2 is present and is a polyether polyol selected from the group consisting of polyoxyethylene polyol, polyoxypropylene polyol, and polyoxypropylene polyoxyethylene polyol.

4. The polyurethane composition as claimed in claim 1, wherein the at least one acid SA has a pKₐ of ≤3.

5. The polyurethane composition as claimed in claim 1, wherein the proportion of the at least one acid SA is 0.8 to 2.0 mM, based on 100 g of the polyurethane composition.

6. The polyurethane composition as claimed in claim 1, wherein the at least one acid SA having a pKₐ of ≤5 is an organic acid.

7. The polyurethane composition as claimed in claim 1, wherein the polyol mixture P comprises more than 80% by weight, of the total amount of NCO-reactive groups in the polyurethane composition.

8. The polyurethane composition as claimed in claim 1, wherein the tin catalyst K is an organotin compound.

9. The polyurethane composition as claimed in claim 1, wherein the compound T is present only in a third component C that is not the first component A or the second component B.

10. The polyurethane composition as claimed in claim 1, wherein the molar ratio (T/K) is 3:1 to 7.5:1.

11. The polyurethane composition as claimed in claim 1, wherein the molar ratio (NCO/K) is 50 to 125.

12. A pack consisting of a package containing the polyurethane composition as claimed in claim 1, having at least two separate chambers respectively containing a first component A or a second component B, as described for the polyurethane composition as claim 1.

13. A process for producing a building waterproofing system, using a polyurethane composition as claimed in claim 1, the process comprising:
a) mixing of the first component (A) and the second component (B), and also the at least one filler F, the at least one tin catalyst K, and the at least one compound T,
b) applying the mixed material to a substrate,
c) optionally smoothing the applied mixed material, and
d) curing the applied mixed material to obtain a building waterproofing system.

14. The process as claimed in claim 13, wherein steps a) to d) are carried out within a temperature range of from 5° C. to 21° C.

15. The process as claimed in claim 13, wherein in step a) a pack consisting of a package containing the polyurethane composition is used.

16. A building waterproofing system comprising the polyurethane composition as claimed in claim 1.
